(19) United States
(12) Patent Application Publication
(10) Pub. No.: US 2008/0117456 A1
(43) Pub. Date: May 22, 2008

(54) Image processing device and program of the same

(75) Inventor: Takehisa Yamaguchi, Ikoma-shi (JP)

Correspondence Address: BUCHANAN, INGERSOLL & ROONEY PC, POST OFFICE BOX 1404, ALEXANDRIA, VA, 22313-1404, US

(73) Assignee: KONICA MINOLTA BUSINESS TECHNOLOGIES, INC., Tokyo (JP)

(21) Appl. No.: 11/979,804

(22) Filed: Nov. 8, 2007

(30) Foreign Application Priority Data
Nov. 20, 2006 (JP) 2006-313082

(51) Int. Cl. G06K 1/00

(52) U.S. Cl. 358/1.15

(57) ABSTRACT

There is provided an image processing device and a program for image processing. The device is capable of easily handling different deadlines for reply, wherein the deadline depends on the time at which counting of time starts and varies according to the time. In the device of the present invention, a timing unit starts counting time when a print instruction receiving unit receives a print instruction of a file through an operating unit. On the print medium which a printer unit prints out, an identification mark is additionally printed. A content of a process for the image data obtained through the reading by a scanner unit is changed according to whether the time at which the scanner unit reads the print medium on which the identification mark is added is on or before the deadline for reply being set to the file or not.

This application is based on the application No. 2006-313082 filed in Japan, the contents of which are hereby incorporated by reference.

### BACKGROUND OF THE INVENTION

1. Field of the Invention

The present invention relates to an image processing device and a program of processing an image.

2. Description of the Related Art

JP No. 07-193595 A discloses a circulation method for an electronic mail system. In this method, a time limit of a process to an electronic mail is set and the system prompts a user to perform the process as the time limit draws on.

In the above approach, the process that has been set at first cannot be changed. Hence, it is impossible to alter the content of the process to be done after the time limit from the content of the process being set to be done before the time limit whereby more flexible operation be achieved.

### SUMMARY OF THE INVENTION

It is an object of the present invention to provide an image processing device and a program of processing an image that can easily switch a content of a process to image data according to whether it is before or after a reply deadline, which is counted from a time count start time.

The object described above is achieved by a first image processing device according to the present invention which includes a printer unit which prints an image on a print medium and a scanner unit which reads the image printed on the print medium to obtain image data. The image processing device further includes: a reply deadline information extracting unit which extracts information about a reply deadline being set in a file from the file; a timing unit which starts counting time when an instruction for printing the file is received; and an image data processing controlling unit which changes a content of a process to the image data which is obtained through the reading of the print medium by the scanner unit, according to whether the time at which the scanner unit reads the print medium on which the content of the file is printed falls within the time which extends from the start time of the counting time by the timing unit to the reply deadline or not.

The program according to the present invention is a program stored on a computer readable medium and may be installed in an image processing device which has a printer unit which prints an image on a print medium and a scanner unit which reads the image printed on the print medium to obtain image data. The program includes: code that extracts information about a reply deadline being set in a file from the file; code that starts counting time when an instruction for printing the file is received; and code that changes a content of a process to the image data which is obtained through the reading of the print medium by the scanner unit, according to whether the time at which the scanner unit reads the print medium on which the content of the file is printed falls within the time which extends from the start time of the counting time to the reply deadline or not.

The image processing device and the like according to the present invention provide an effect of easily coping with the change of the content of the process to the image data according to whether a time is before or after the reply deadline from the time count start time.

Other objects and further features of the present invention will be apparent from the following detailed description when read in conjunction with the accompanying drawings.

### BRIEF DESCRIPTION OF THE DRAWINGS

In the accompanying drawings:

FIG. 1 is a diagram of an example of an appearance of an MFP 100 according to an embodiment of the present invention;

FIG. 2 is a diagram of an example of a hardware configuration of the MFP 100 according to the embodiment;

FIG. 3 is a block diagram of an example of a functional configuration of the MFP 100 according to the embodiment; and

FIG. 4 is a flowchart of an example of the processes of the embodiment.

### DETAILED DESCRIPTION OF THE PREFERRED EMBODIMENTS

A preferred embodiment of the present invention will be described with reference to the drawings.

(1) Hardware Configuration of MFP 100

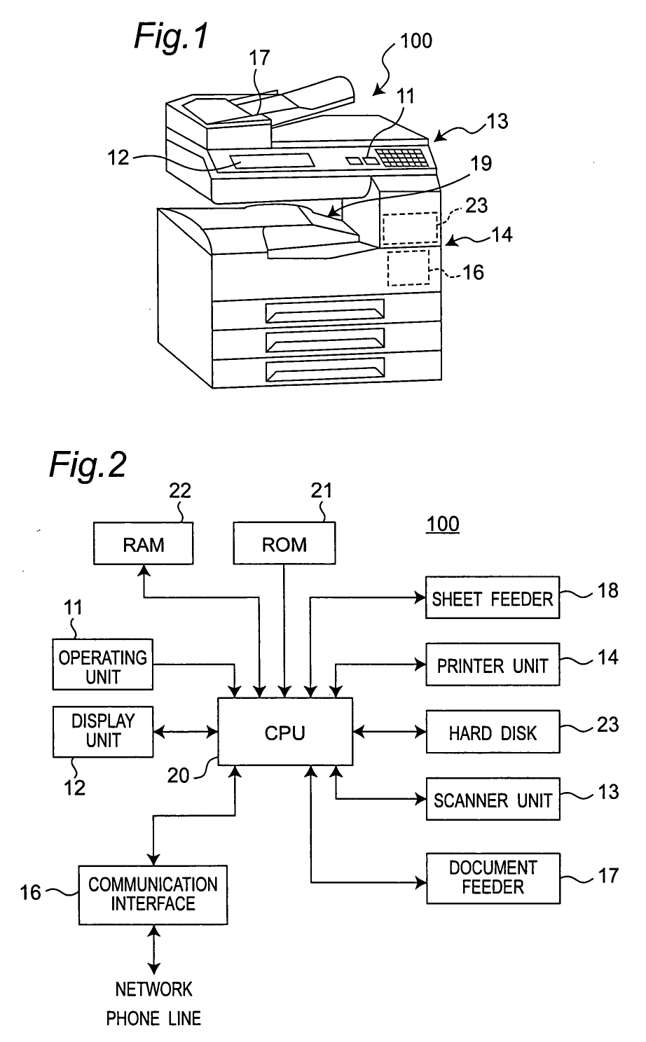

FIG. 1 is a diagram of an example of an appearance of a multifunction peripheral (MFP) 100 according to the embodiment. The MFP 100 is an image processing device having functions of a copying machine, a network printer, a scanner, a facsimile, a document server, and the like collectively. The MFP is sometimes referred to as a complex machine, an All In One (AIO), or a Scan Print Copy (SPC). FIG. 2 is a diagram of an example of a hardware configuration of the MFP 100 according to the present embodiment.

The MFP 100 includes an operating unit 11, a display unit 12, a scanner unit 13, a printer unit 14, a communication interface 16, a document feeder 17, a sheet feeder 18, a central processing unit (CPU) 20, a read only memory (ROM) 21, a random access memory (RAM) 22, a hard disk 23, and the like.

The operating unit 11 includes: a plurality of keys for inputting numerals, characters and symbols; a sensor for recognizing the pressed key; a transmission circuit for transmitting a signal indicating the recognized key to the CPU 20; and the like.

The display unit 12 displays: a screen for displaying a message to a user; a screen for prompting a user to input setting contents or processing contents; a screen for indicating the result of processes performed by the MFP 100; and the like. In the present embodiment, a touch panel is used as the display unit 12. The touch panel may also be included in the operating unit 11. The touch panel has a function of detecting a position in the touch panel touched by a user's finger and transmitting the signal indicating the detection result to the CPU 20.

The scanner unit 13 irradiates light on a surface of a document and reads the document image by detecting the reflected light to create digital image data (here, density data representing density of RGB or black).

The image data thus obtained is used for printing at the printer unit 14. In addition, the data may be converted into a file of a format such as TIFF, PDF, JPEG or the like and then stored in the hard disk 23. The image data may also be converted into facsimile data and used for facsimile transmission. The image data may also be transmitted to the outside as an attachment to an e-mail. The document feeder 17 is provided above the main body of the MFP 100 and used for sequentially feeding one or a plurality of documents to the scanner unit 13.

The printer unit 14 can print an image read by the scanner unit 13, an image of data transmitted from an external device such as another MFP connected through a network such as a Local Area Network (LAN), or an image of the facsimile data received through facsimile, onto a print medium such as paper or film.

The sheet feeder 18 is provided below the main body of the MFP 100, for example, and used for feeding a print medium to the printer unit 14. The print medium on which an image is printed by the printer unit 14 is ejected onto a catch tray 19 (see FIG. 1), for example.

The communication interface 16 is an interface for communicating with an external device such as a personal computer (PC), an e-mail server, and the like through a network such as a LAN or a Wide Area Network (WAN), and for performing transmission and reception of facsimile through a phone line. The communication interface 16 may include a network interface card (NIC), a terminal adapter (TA), or the like, for example.

Stored in the ROM 21 are a program and data for realizing basic functions of the MFP 100 such as reading (scanning) of an image, duplicating (copying) a document, transmitting or receiving facsimile data, printing via a network, and operating as a document server (box function). Furthermore, the ROM 21 stores programs and data for realizing the functions according to the present embodiment.

Some or all of the programs or data may be installed in the hard disk 23. In this case, the program or data installed in the hard disk 23 may be loaded onto the RAM 22 as necessary.

The functions described in the present embodiment can be realized not only by the CPU 20 but also dedicated hardware. Moreover, some of the functions may be realized by using functions provided by a general-purpose program such as an operating system (OS).

(2) Functional Configuration of MFP 100

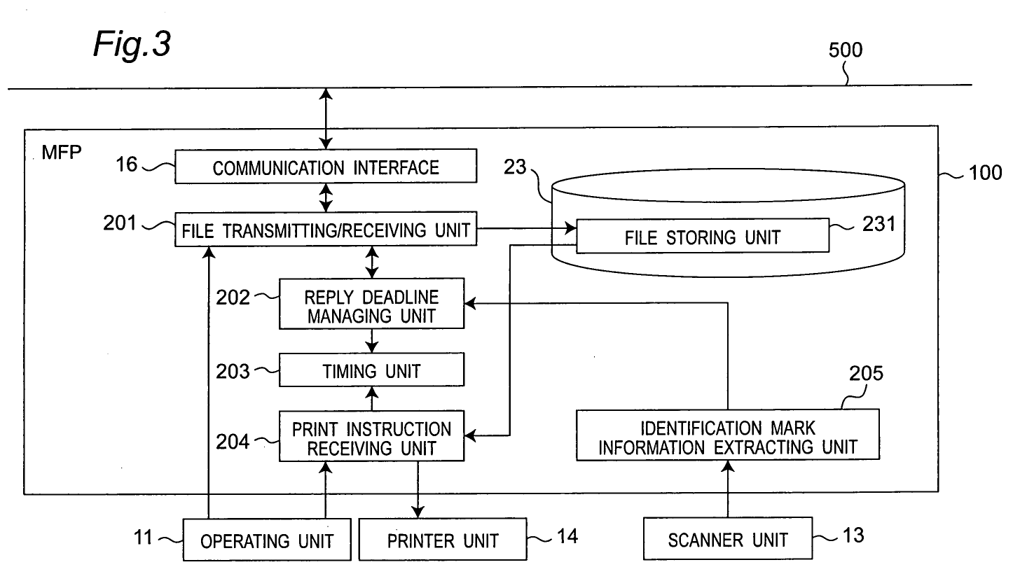

FIG. 3 is a block diagram for explaining an example of the functional configuration of the MFP 100 according to the present embodiment. The MFP 100 includes: a file transmitting/receiving unit 201; a reply deadline managing unit 202; a timing unit 203; a print instruction receiving unit 204; and an identification mark information extracting unit 205. The function of each unit is realized by executing the program stored in the ROM 21 and/or RAM 22 by the CPU 20.

It is to be noted that the hard disk 23 includes a file storing unit 231 according to the present embodiment. The file storing unit 231 can store a file, to which, in this embodiment, the present invention is applied.

The file transmitting/receiving unit 201 transmits and receives a file through the communication interface 16 and the network 500 such as a LAN.

In the present embodiment, the file to which the present invention is applied includes information about a reply deadline. Here, the information about the reply deadline indicates the deadline for reply from when an instruction for printing the file is received. The reply deadline managing unit 202 acquires the information about the reply deadline from the file and manages the reply deadline. The information about the reply deadline can be set as property information of the file, for example.

The timing unit 203 starts counting time at a time when the instruction for printing the file is given. The reply deadline managing unit 202 is capable of determining whether it is on or before the reply deadline or not by referring to the status of the timing by the timing unit 203. The print instruction receiving unit 204 can accept the instruction for printing, which may be inputted through the operating unit 11. The instruction for printing is sent to the timing unit 203 to start the counting of time.

The identification mark information extracting unit 205 extracts information indicated as an identification mark. The identification mark may be added onto the print medium on which the file is printed.

(3) Processes in MFP 100

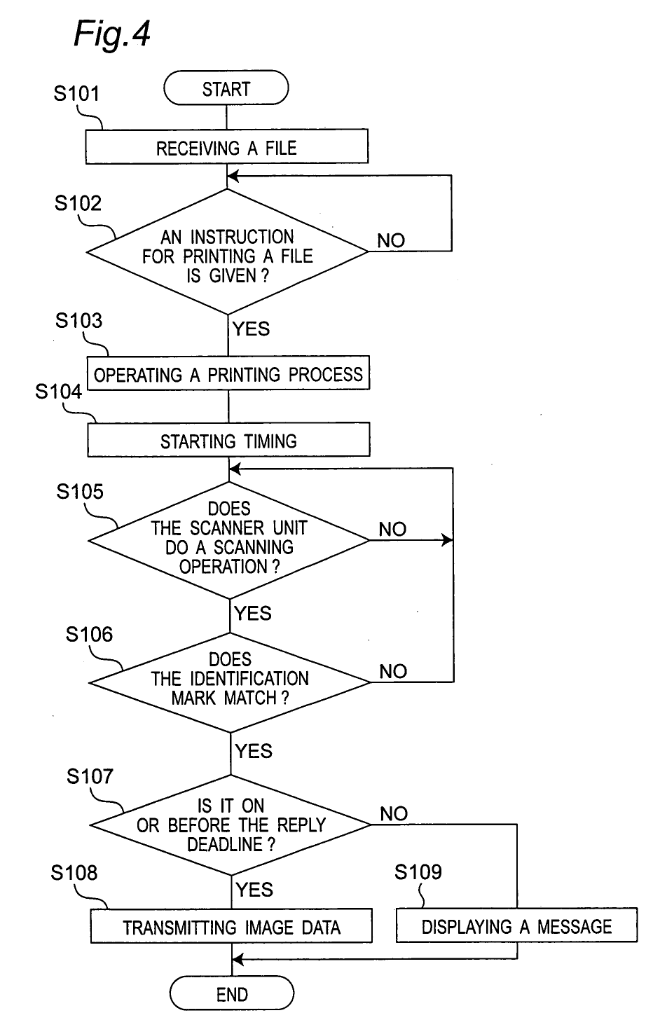

Subsequently, the processes in the MFP 100 will be described. FIG. 4 is a flowchart for explaining an example of the processes. Below, the MFP 100 according to the present embodiment is explained taking a case as an example where a practice examination is carried out at home using the MFP 100.

The MFP 100 receives the file to which the present embodiment will be applied (S101). This file may contain questions, answer sheets, and model answers of the practice examination in a collectively compressed form, for example, and the information about the reply deadline is also included in the file. (In this case, the reply deadline being added to the file represents the information about the examination time.)

When the print instruction receiving unit 204 receives the instruction for printing (“YES” in S102), a printing process is operated (S103), and timing unit 203 starts the counting of time (S104). In the step S103 of the present embodiment, the decompression of the file and printing out of the questions and answer sheets can be carried out.

Here, the answer sheet is printed out with a predetermined identification mark. A barcode may be used as the identification mark, for example. Alternatively, is the identification mark may be printed in the form of a character or a symbol. The identification mark may represent information from which the MFP can acquire the reply deadline at least. The information from which the MFP can acquire the reply deadline may be a filename, an identifier of the sheet of the questions, or the like, not only just the information about the reply deadline itself. Further, the identification mark may represent those which are the encrypted form of the information described above.

The user writes answers for the practice examination in the answer sheet. And then the user causes the scanner unit 13 to read the written answers. If an image is read out by the scanner unit 13 (“YES” in S105) and if the information acquired from the identification mark is matched to the information which had been printed out (“YES” in S106), determination whether it is on or before the reply deadline from the start of the counting of time by the timing unit 203 or not (S107). This determination corresponds to determination whether the reading of the image is performed within the examination time of the practice examination or not.

In the present embodiment, if it is on or before the reply deadline (“YES” in S107), the image data obtained through the reading of the answer sheets using the scanner unit 13 is transmitted to the sender of the file for marking (S108). If it is neither on nor before the reply deadline (“NO” in S107), the image data is not transmitted. In order to notify the user of such state, the message which indicates that it is after the reply deadline is displayed (S109). In this case, the user cannot have marking service. As described above, the examination time can be managed appropriately in the case where the examination is held, for example, at home by changing processes according to whether the image data is read by the scanner unit 13 on or before the reply deadline or not.

It may be configured that the file such as the sheet of questions which having been transmitted be deleted after the reply deadline passes by. In addition, it may also be configured that the model answers automatically be printed regardless of whether it is on or before the reply deadline or not. The model answers may not be contained in the file which is transmitted at first and can lately be transmitted after the reply deadline passes by.

(Modification)

The embodiment of the present invention has been described above. It is needless to say that the present invention is not limited to the specific examples described in the above embodiment. In the present invention, a modification below may also be possible, for example.

(i) In the above described embodiment, processes are changed such that the image data should be transmitted or not depending on whether it is before the reply deadline or it is after the reply deadline. It may also be configured that processes may be changed such that the image data is transmitted in the case where it is on or before the reply deadline but the answers are received via facsimile in the case where it is after the reply deadline. In this case, entirely different processes are performed on/before and after the reply deadline.

(ii) Although the above embodiment has been explained using the practice examination being held at home, the application of the present invention is not limited to the case of such practice examinations.

(iii) The file to which the present invention is applied is not limited to those transmitted from the outside through a network, but files stored for distribution in various recording media such as a flexible disk, a CD-ROM, a DVD-ROM, a USB memory, or the like can be used.

The present invention is applicable to, for example, an image processing device.

The present invention is further also applicable to a computer program stored on a computer readable medium such as a flexible disk (FD), a compact disc read only memory (CD-ROM), or the like.

What is claimed is:

1. An image processing device, comprising:
a printer unit that prints an image on a print medium;
a scanner unit that reads the image on the print medium to obtain image data;
a reply deadline information extracting unit that extracts information about a reply deadline being set in a file from the file;
a timing unit that starts counting time when an instruction for printing the file is received; and
an image data processing controlling unit that changes a content of a process to the image data which is obtained through the reading of the print medium by said scanner unit, according to whether the time at which said scanner unit reads the print medium on which the content of the file is printed falls within the time which extends from the start time of the counting time by the timing unit to the reply deadline or not.

2. The image processing device according to claim 1, further comprising an identification mark information extracting unit that extracts information indicated as an identification mark from the image data obtained through the reading of the print medium by said scanner unit, and wherein said printer unit prints the identification mark which represents the information from which the reply deadline is acquired onto the print medium when said printer unit prints the content of the file.

3. The image processing device according to claim 2, wherein:
the identification mark represents the information from which the reply deadline is acquired; and
the information is encrypted.

4. The image processing device according to claim 1, wherein
the information about the reply deadline is set as property information of the file.

5. The image processing device according to claim 2, wherein
the information about the reply deadline is set as property information of the file.

6. The image processing device according to claim 3, wherein
the information about the reply deadline is set as property information of the file.

7. A program stored on a computer readable medium for use in an image processing device, the image processing device including a printer unit which prints an image on a print medium and a scanner unit which reads the image on the print medium to obtain image data, comprising:
code that extracts information about a reply deadline being set in a file from the file;
code that starts counting time when an instruction for printing the file is received; and
code that changes a content of a process to the image data which is obtained through the reading of the print medium by the scanner unit, according to whether the time at which the scanner unit reads the print medium on which the content of the file is printed falls within the time which extends from the start time of the counting time to the reply deadline or not.
